(19) United States
(12) Patent Application Publication
(10) Pub. No.: US 2025/0358745 A1
(43) Pub. Date: Nov. 20, 2025

(54) METHOD AND APPARATUS FOR WAKING UP NETWORK DEVICE, DEVICE AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/870,609

(22) PCT Filed: Jun. 2, 2022
(86) PCT No.: PCT/CN2022/096959

§ 371 Date: Nov. 29, 2024

(51) Int. Cl. H04W 52/36; H04W 52/02

(52) U.S. Cl. CPC H04W 52/367; H04W 52/0229

(57) ABSTRACT

A device, computer readable medium and method for waking up a network device, involving user equipment, a first network device, and a second network device. The method includes determining and transmitting a wake-up signal from the user equipment based on transmit power, which is dynamically adjusted using communication protocol parameters such as initial transmit power, step increments, and maximum power thresholds. Wake-up signals are transmitted multiple times within a set period to ensure reliable reception. The first network device processes the wake-up signal, assesses signal quality, and interacts with the second network device to determine wake-up conditions based on agreed communication protocols and signal quality thresholds. The second network device manages wake-up coordination among multiple first network devices, identifying devices meeting quality conditions and transmitting wake-up indications and configuration details.

### CROSS-REFERENCE

The present application is a U.S. National Stage of International Application No. PCT/CN2022/096959, filed on Jun. 2, 2022, the contents of all of which are incorporated herein by reference in their entirety for all purposes.

### BACKGROUND OF THE INVENTION

At present, one way to reduce the energy consumption of a base station is to reduce unnecessary downlink transmission. One way to reduce downlink transmission is to put the base station to be in a sleep state. The base station in the sleep state stops downlink transmission but has an uplink receiving function.

### SUMMARY OF THE INVENTION

The present disclosure relates to the technical field of wireless communications, in particular to a method and device for waking up a network device, a device and a storage medium.

According to a first aspect of an example of the present disclosure, a method for waking up a network device is provided, performed by user equipment, and includes:
determining a transmit power for transmitting a wake-up signal to a first network device; and
transmitting the wake-up signal to the first network device based on the transmit power.

According to a second aspect of an example of the present disclosure, a method for waking up a network device is provided, performed by a first network device, and includes: receiving a wake-up signal from user equipment;
determining signal quality indication information of the wake-up signal; and
transmitting the signal quality indication information to a second network device.

According to a third aspect of an example of the present disclosure, a method for waking up a network device is provided, performed by a second network device, and includes:
receiving signal quality indication information of wake-up signals from N first network devices; and
determining, based on the signal quality indication information, a first network device that meets a second set condition from the N first network devices as a to-be-waked-up first network device,
where N is a positive integer and N≥1.

According to a fourth aspect of an example of the present disclosure, a terminal is provided, and includes:
a processor; and
a memory that stores processor-executable instructions, where
the processor is configured to execute the executable instructions in the memory to implement the method for waking up the network device according to the first aspect.

According to a fifth aspect of an example of the present disclosure, a device is provided, and includes:
a processor; and
a memory that stores processor-executable instructions, where
the executable instructions when executed by the processor cause the device to act as the first network device and perform the method according to the second aspect.

According to a sixth aspect of an example of the present disclosure, a device is provided, and includes:
a processor; and
a memory that stores processor-executable instructions, where

the executable instructions when executed by the processor cause the device to act as the second network device and perform the method according to the third aspect.

According to a seventh aspect of an example of the present disclosure, a non-transitory computer-readable storage medium is provided, storing one or more programs configured to be executed by one or more processors of user equipment, the one or more programs comprising instructions which, when executed by the one or more processors, cause the user equipment to perform the method according to the first aspect.

It is to be understood that the above general descriptions and later detailed descriptions are merely examples and illustrations, and cannot limit the present disclosure.

### BRIEF DESCRIPTION OF DRAWINGS

The accompanying drawings are included here to provide a further understanding of examples of the present disclosure and constitute a part of the present application. The examples of the present disclosure and the description are used to explain the examples of the present disclosure and do not constitute an undue limitation to the examples of the present disclosure. In the figures.

The accompanying drawings here, which are incorporated in and constitute a part of the specification, illustrate examples consistent with the examples of the present disclosure and together with the specification serve to explain the principles of the examples of the present disclosure.

FIG. 1 is an architecture schematic diagram of a wireless communication system according to an example;

FIG. 2 is a flowchart of a method for waking up a network device according to an example;

FIG. 3 is a flowchart of a method for waking up a network device according to an example;

FIG. 4 is a flowchart of a method for waking up a network device according to an example;

FIG. 5 is a flowchart of a method for waking up a network device according to an example;

FIG. 6 is a flowchart of a method for waking up a network device according to an example;

FIG. 7 is a flowchart of a method for waking up a network device according to an example;

FIG. 8 is a flowchart of a method for waking up a network device according to an example;

FIG. 9 is a flowchart of a method for waking up a network device according to an example;

FIG. 10 is a flowchart of a method for waking up a network device according to an example;

FIG. 11 is a block diagram of a device for waking up a network device according to an example;

FIG. 12 is a block diagram of a device for waking up a network device according to an example;

FIG. 13 is a block diagram of a device for waking up a network device according to an example;

FIG. 14 is a structure diagram of a device for waking up a network device according to an example; and

FIG. 15 is a structure diagram of a device for waking up a network device according to an example.

### DETAILED DESCRIPTION OF THE INVENTION

The examples of the present disclosure will now be further illustrated with reference to the accompanying drawings and the detailed description.

Examples will be described in detail here, instances of which are illustrated in the accompanying drawings. When the following description refers to the accompanying drawings, unless otherwise indicated, the same numerals in different accompanying drawings indicate the same or similar elements. The implementations described in the following examples do not represent all implementations consistent with the examples of the present disclosure. Rather, they are merely instances of devices and methods consistent with some aspects of the present disclosure as detailed in the appended claims.

The terms used in the examples of the present disclosure are merely for the purpose of describing specific examples, and not intended to limit the examples of the present disclosure. The singular forms “one” and “the” used in the examples of the present disclosure and the appended claims are also intended to include the majority forms unless the context clearly indicates other meanings. It should also be understood that the term “and/or” as used here refers to and includes any or all possible combinations of one or more associated listed items.

It should be understood that although the terms first, second, third, etc. may be used to describe various information in the examples of the present disclosure, such information should not be limited to these terms. These terms are merely used to distinguish the same type of information from each other. For example, without departing from the scope of the examples of the present disclosure, first information may also be referred to as second information, and similarly, the second information may also be referred to as the first information. Depending on the context, the words “if” and “in a case that” as used here may be interpreted as “at the time of” or “when” or “in response to determining that”.

The examples of the present disclosure will be described below in detail, instances of which are illustrated in the accompanying drawings. The same or similar reference numerals refer to the same or similar elements throughout. The examples described below with reference to the accompanying drawings are exemplary, and are intended to be used to be illustrative of the present disclosure and should not be construed as limiting the present disclosure.

At present, one way to reduce the energy consumption of a base station is to reduce unnecessary downlink transmission. One way to reduce downlink transmission is to put the base station to be in a sleep state. The base station in the sleep state stops downlink transmission, but has an uplink receiving function and can receive a wake-up signal transmitted by a terminal. User Equipment (UE) needs to transmit a wake-up signal to the sleep base station when needing to perform communication services. After receiving the wake-up signal, the base station will resume the normal transceiving function and provide communication services for the UE.

The UE transmits the uplink wake-up signal to wake up the base station, which can be used in a heterogeneous network or homogeneous network. In the heterogeneous network, there are a plurality of small cells under the wide area coverage of a macro cell, the small cells are used for coverage enhancement or hotspot coverage, and the coverage range of the small cells is within the coverage range of the macro station. In the homogeneous network, the coverage range of each adjacent base station does not overlap.

In view of this, the present disclosure provides a method and device for waking up a network device, a device and a storage medium.

As shown in FIG. 1, a method for waking up a network device provided by an example of the present disclosure may be applied to a wireless communication system 100, and the wireless communication system 100 may include, but is not limited to, a network device 101 and user equipment 102. The user equipment 102 is configured to support carrier aggregation, and the user equipment 102 may be connected to a plurality of carrier units of the network device 101, the carrier units including a primary carrier unit and one or more secondary carrier units.

It should be understood that the above wireless communication system 100 can be applied to both low-frequency scenarios and high-frequency scenarios. Application scenarios for the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communications system or a future evolved public land mobile network (PLMN) system, etc.

The user equipment 102 shown above may be user equipment (UE), a terminal, an access terminal, a terminal unit, a terminal station, a mobile station (MS), a remote station, a remote terminal, a mobile terminal, a wireless communication device, a terminal agent or user equipment, etc. The user equipment 102 may have a wireless transceiving function and is capable of communicating (e.g. wireless communication) with one or more network devices 101 of one or more communication systems and receiving network services provided by the network device 101, and the network device 101 here includes, but is not limited to, a base station shown in the figure.

The user equipment 102 may be a cellular phone, a cordless phone, a session initiation protocol (SIP) phone, a wireless local loop (WLL) station, a personal digital assistant (PDA) device, a handheld device with a wireless communication function, a computing device or other processing devices connected to a wireless modem, an on-board device, a wearable device, user equipment in future 5G networks or user equipment in future evolved PLMN networks, etc.

The network device 101 may be an access network device (or access network site). The access network device refers to a device providing a network access function, such as a radio access network (RAN) base station. The network device may specifically include a base station (BS) device, or include a base station device and a radio resource management device used to control the base station device. The network device may further include a relay station (relay device), an access point, a base station in future 5G networks, a base station in future evolved PLMN networks, or an NR base station, etc. The network device may be a wearable device or on-board device. The network device may also be a communication chip having a communication module.

For example, the network device 101 includes, but is not limited to, gnodeB (gNB) in 5G, evolved node B (eNB) in the LTE system, a radio network controller (RNC), node B (NB) in a WCDMA system, a wireless controller under the CRAN system, a base station controller (BSC), a base transceiver station (BTS) in a GSM system or CDMA system, home base stations (e.g., home evolved nodeB, or home node B, HNB), a baseband unit (BBU), a transmitting and receiving point (TRP), a transmitting point (TP) or a mobile switching center, etc.

In heterogeneous network scenarios, one way to save a network's energy is that a small cell is in a sleep state and needs to be waked up merely when services need to be transmitted. If the small cell in the sleep state receives a wake-up signal from the user equipment, it needs to determine whether the small cell is waked up.

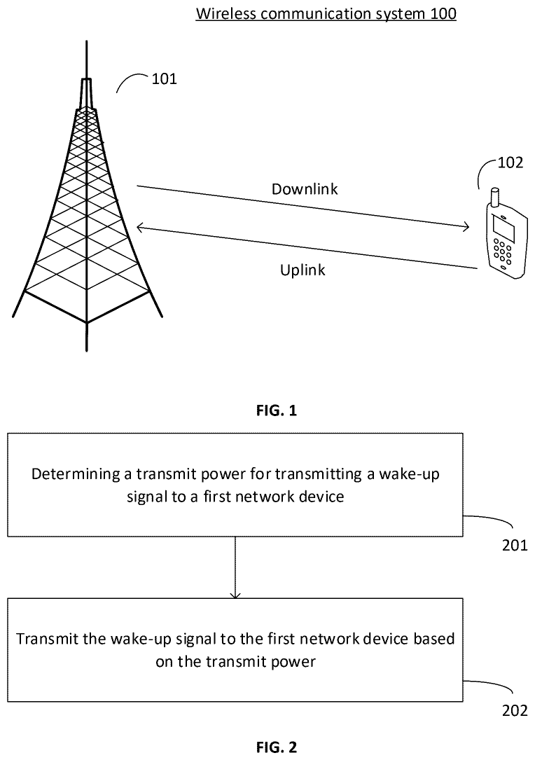

An example of the present disclosure provides a method for waking up a network device, and the method is performed by user equipment. FIG. 2 is a flowchart of a method for waking up a network device according to an example. As shown in FIG. 2, the method includes steps 201 and 202.

In step 201, determining a transmit power for transmitting a wake-up signal to a first network device.

In step 202, transmitting the wake-up signal to the first network device based on the transmit power.

In one implementation, the user equipment transmits the wake-up signal to the first network device by using conventional transmit power of the user equipment or the transmit power agreed upon by a communication protocol. The first network device may include a small cell. Then the first network device transmits signal quality indication information of the wake-up signal to a second network device. The second network device may include a macro cell. Thus, the second network device selects a first network device with the best signal quality based on the signal quality indication information received from each first network device, and indicates the first network device with the best signal quality to wake up.

It should be noted that for the heterogeneous network scenarios, the small cell may be in a sleep state. When a to-be-waked-up small cell is selected, a small cell with the best signal quality is selected.

In one implementation, the user equipment determines the transmit power for transmitting the wake-up signal to the first network device, and then transmits the wake-up signal to the first network device based on the transmit power. The user equipment may transmit the wake-up signal to one or more first network devices with the same transmit power.

For example, the user equipment determines the transmit power for transmitting the wake-up signal to the first network device as its own conventional uplink transmit power. For example, the user equipment transmits the wake-up signal to the first network device by using conventional uplink transmit power 20-26 dBm.

For example, the user equipment determines the transmit power for transmitting the wake-up signal to the first network device based on an agreement of a communication protocol.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

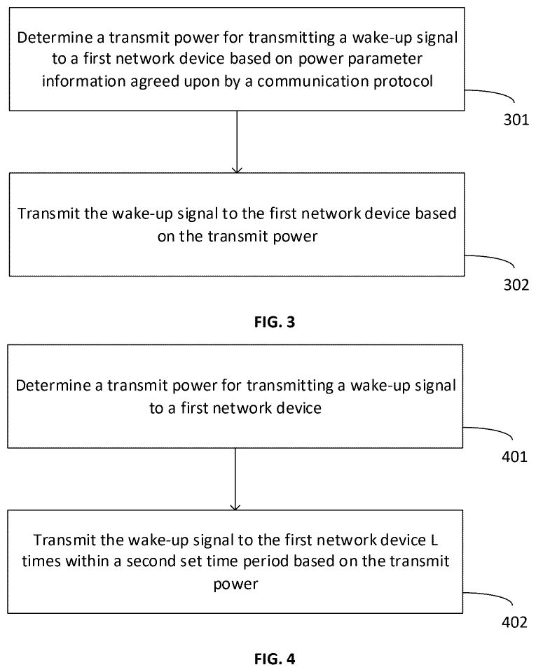

An example of the present disclosure provides a method for waking up a network device, and the method is performed by user equipment. The method may be executed independently or in conjunction with any other example of the present disclosure. FIG. 3 is a flowchart of a method for waking up a network device shown according to an example. As shown in FIG. 3, the method includes steps 301 and 302.

In step 301, determining a transmit power for transmitting a wake-up signal to a first network device based on power parameter information agreed upon by a communication protocol.

In step 302, transmitting the wake-up signal to the first network device based on the transmit power.

In one implementation, the user equipment determines the transmit power for transmitting the wake-up signal to the first network device based on the power parameter information agreed upon by the communication protocol, and then transmits the wake-up signal to the first network device based on the transmit power. The user equipment may transmit the wake-up signal to one or more first network devices with the same transmit power.

In one implementation, the power parameter information agreed upon by the communication protocol includes an initial transmit power, a set power step and a maximum transmit power. Determining the transmit power based on the power parameter information agreed upon by the communication protocol, includes: determining the transmit power as the initial transmit power; and in response to determining that a network device starting signal meeting a first set condition is not received within a first set time period, successively increasing the transmit power by a set power step until the network device starting signal meeting the first set condition is received within the first set time period or the transmit power is increased to the maximum transmit power.

For example, the user equipment first transmits the wake-up signal based on the initial transmit power agreed upon by the communication protocol, if the network device starting signal meeting the first set condition and from the first network device is not received within the first set time period, the initial transmit power is increased by the set power step, the wake-up signal is transmitted with a increased transmit power, and then whether the network device starting signal meeting the first set condition is received within the first set time period is judged again. If the network device starting signal meeting the first set condition is not received within the first set time period, the transmit power is increased by the set power step again, and the wake-up signal is transmitted with the increased transmit power until the network device starting signal meeting the first set condition is received within the first set time period or the transmit power is increased to the maximum transmit power.

In one implementation, the network device starting signal is a synchronizing signal block, and the first set condition is that reference signal receiving power is greater than a first set threshold value. In addition, the first set time period may be agreed upon by the communication protocol, or may be configured by a second network device.

In this case, when no network device starting signal meeting the condition is received, the transmit power of the wake-up signal is increased to ensure that the wake-up signal transmitted by the user equipment can be received by the first network device.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

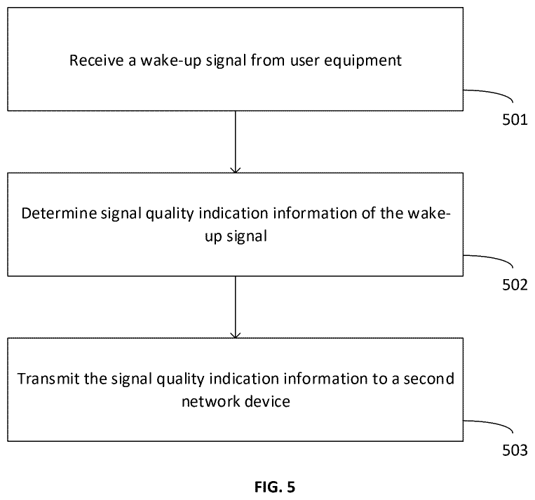

An example of the present disclosure provides a method for waking up a network device, and the method is performed by user equipment. The method may be executed independently or in conjunction with any other example of the present disclosure. FIG. 4 is a flowchart of a method for waking up a network device according to an example. As shown in FIG. 4, the method includes steps 401 and 402.

In step 401, determining a transmit power for transmitting a wake-up signal to a first network device.

In step 402, transmitting the wake-up signal to the first network device L times within a second set time period based on the transmit power.

Where L is a positive integer and L≥2.

In one implementation, the user equipment determines the transmit power for transmitting the wake-up signal to the first network device, and then transmits the wake-up signal to the first network device within the second set time period based on the transmit power. The user equipment may transmit the wake-up signal to one or more first network devices with the same transmit power. The second set time period may be agreed upon by the communication protocol, or may be configured by a second network device.

The user equipment transmits the wake-up signal several times over a period of time with the same transmit power in order to facilitate the first network device to evaluate an average channel state and thus determine the channel quality more accurately.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

An example of the present disclosure provides a method for waking up a network device, and the method is performed by a first network device. FIG. 5 is a flowchart of a method for waking up a network device according to an example. As shown in FIG. 5, the method includes steps 501, 502 and 503.

In step 501, receiving a wake-up signal from user equipment.

In step 502, determining signal quality indication information of the wake-up signal.

In step 503, transmitting the signal quality indication information to a second network device.

In one implementation, the user equipment transmits the wake-up signal to the first network device, namely a small cell, by using conventional transmit power of the user equipment or the transmit power agreed upon by a communication protocol. Then the first network device transmits signal quality indication information of the wake-up signal to a second network device, namely a macro cell. Thus, the second network device selects a first network device with the best signal quality based on the signal quality indication information received from each first network device, and indicates the first network device with the best signal quality to wake up.

It should be noted that for the heterogeneous network scenarios, the small cell may be in a sleep state. When a to-be-waked-up small cell is selected, a small cell with the best signal quality is selected.

In one implementation, the first network device receives the wake-up signal transmitted by the user equipment and determines the signal quality indication information of the wake-up signal. Then, the first network device transmits the signal quality indication information to the second network device, such that the second network device selects, based on the signal quality indication information received from a plurality of first network devices, the first network device with the best signal quality to wake up, namely, start.

For example, the signal quality indication information may include reference signal receiving power and/or a reference signal signal-noise ratio, etc. In one implementation, the best signal quality indicated by the signal quality indication information may include: the reference signal receive power indicated by the signal quality indication information being the maximum, and/or the reference signal signal-noise ratio indicated by the signal quality indication information being the maximum.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

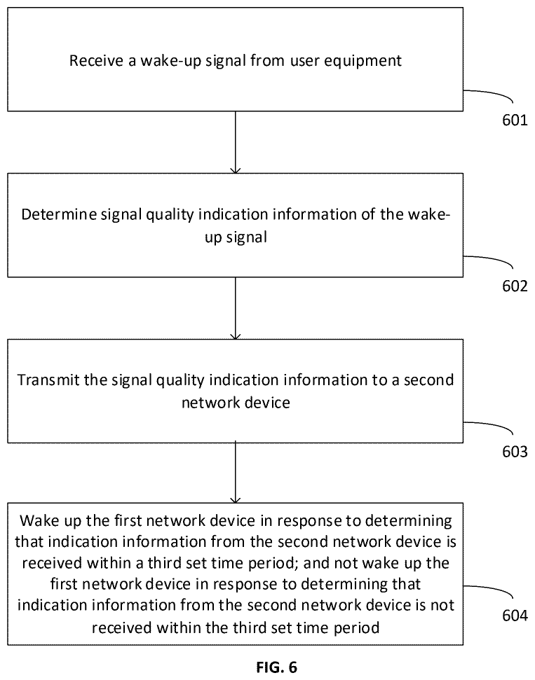

An example of the present disclosure provides a method for waking up a network device, and the method is performed by a first network device. The method may be executed independently or in conjunction with any other example of the present disclosure. FIG. 6 is a flowchart of a method for waking up a network device according to an example. As shown in FIG. 6, the method includes steps 601, 602, 603 and 604.

In step 601, receiving a wake-up signal from user equipment.

In step 602, determining signal quality indication information of the wake-up signal.

In step 603, transmitting the signal quality indication information to a second network device.

In step 604, waking up the first network device in response to determining that indication information from the second network device is received within a third set time period; and not waking up the first network device in response to determining that indication information from the second network device is not received within the third set time period.

Where the indication information is configured to indicate to wake up the first network device.

In one implementation, the first network device receives the wake-up signal transmitted by the user equipment and determines the signal quality indication information of the wake-up signal. Then, the first network device transmits the signal quality indication information to the second network device, such that the second network device selects, based on the signal quality indication information received from a plurality of first network devices, the first network device with the best signal quality to wake up, namely, start. If the first network device receives the indication information of the second network device used to indicate to wake up within the third set time period, the first network device performs a wake-up operation; and if the first network device does not receive the indication information of the second network device used to indicate to wake up within the third set time period, the first network device is still kept in a sleep state.

For example, the third set time period is configured by the second network device. In one implementation, the method further includes: the first network device receives configuration information from the second network device; and based on the configuration information, the third set time period is determined.

For example, the third set time period is determined based on the agreement of the communication protocol. In one implementation, the method further includes: the first network device determines the third set time period based on the agreement of the communication protocol.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

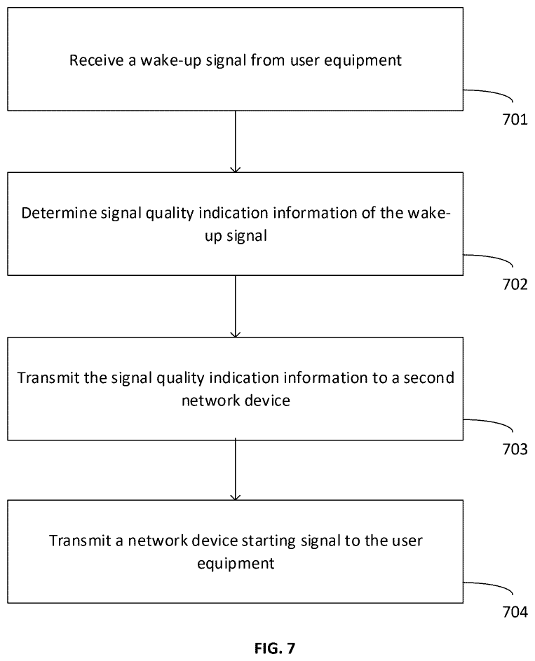

An example of the present disclosure provides a method for waking up a network device, and the method is performed by a first network device. The method may be executed independently or in conjunction with any other example of the present disclosure. FIG. 7 is a flowchart of a method for waking up a network device according to an example. As shown in FIG. 7, the method includes steps 701, 702, 703, and 704.

In step 701, receiving a wake-up signal from user equipment.

In step 702, determining signal quality indication information of the wake-up signal.

In step 703, transmitting the signal quality indication information to a second network device.

In step 704, transmitting a network device starting signal to the user equipment.

In one implementation, the first network device receives the wake-up signal transmitted by the user equipment and determines the signal quality indication information of the wake-up signal. Then, the first network device transmits the signal quality indication information to the second network device, such that the second network device selects, based on the signal quality indication information received from a plurality of first network devices, the first network device with the best signal quality to wake up, namely, start. When the first network device receives an indication of the second network device to determine to start, the network device starting signal is transmitted to the user equipment to inform the user equipment that the first network device is started.

For example, the network device starting signal is a synchronizing signal block, such that the user equipment conveniently performs an access operation.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

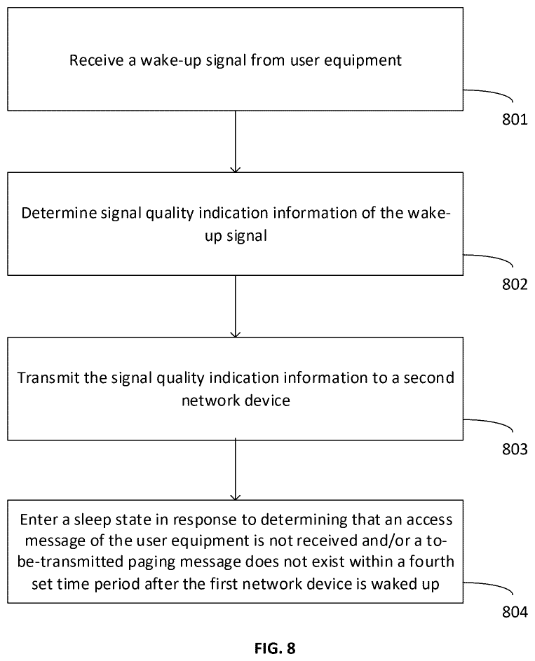

An example of the present disclosure provides a method for waking up a network device, and the method is performed by a first network device. The method may be executed independently or in conjunction with any other example of the present disclosure. FIG. 8 is a flowchart of a method for waking up a network device according to an example. As shown in FIG. 8, the method includes steps 801, 802, 803, and 804.

In step 801, receiving a wake-up signal from user equipment.

In step 802, determining signal quality indication information of the wake-up signal.

In step 803, transmitting the signal quality indication information to a second network device.

In step 804, entering a sleep state in response to determining that an access message of the user equipment is not received and/or a to-be-transmitted paging message does not exist within a fourth set time period after the first network device is waked up.

In one implementation, the first network device receives the wake-up signal transmitted by the user equipment and determines the signal quality indication information of the wake-up signal. Then, the first network device transmits the signal quality indication information to the second network device, such that the second network device selects, based on the signal quality indication information received from a plurality of first network devices, the first network device with the best signal quality to wake up, namely, start. If the access message of the user equipment is not received and/or the to-be-transmitted paging message does not exist within the fourth set time period after the first network device is waked up, it enters a sleep state.

A duration of the fourth set time period may be indicated by the second network device, or may be determined by the agreement of the communication protocol, or may be determined by the first network device.

A plurality of first network devices may be waked up at the same time, for example, the plurality of waked-up first network devices correspond to different second network devices. If the user equipment performs a cell access through one waked-up first network device, the other waked-up first network devices have no user equipment to serve and thus enter a sleep state after the fourth set time period.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

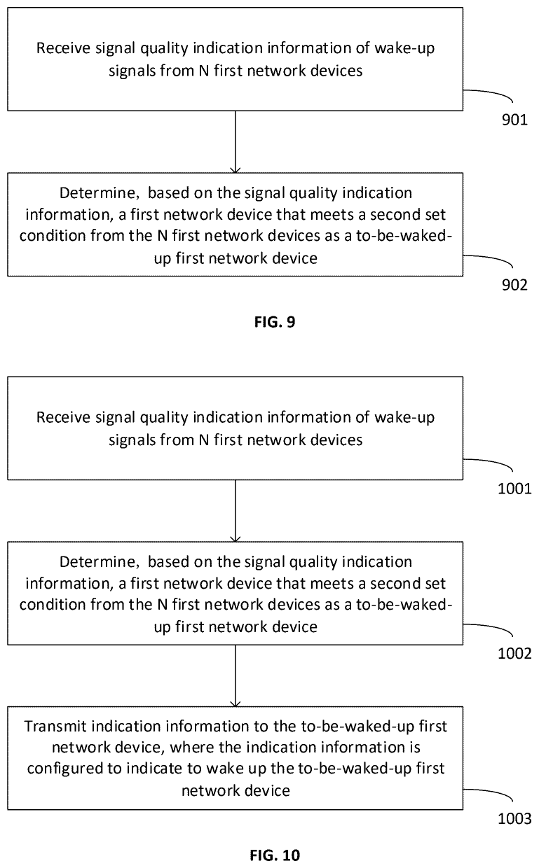

An example of the present disclosure provides a method for waking up a network device, and the method is performed by a second network device. FIG. 9 is a flowchart of a method for waking up a network device according to an example. As shown in FIG. 9, the method includes steps 901 and 902.

In step 901, receiving signal quality indication information of wake-up signals from N first network devices.

In step 902, determining, based on the signal quality indication information, a first network device that meets a second set condition from the N first network devices as a to-be-waked-up first network device.

Where N is a positive integer and N≥1.

In one implementation, the user equipment transmits the wake-up signal to the first network device, namely a small cell, by using conventional transmit power of the user equipment or the transmit power agreed upon by a communication protocol. Then the first network device transmits signal quality indication information of the wake-up signal to a second network device, namely a macro cell. Thus, the second network device selects a first network device with the best signal quality based on the signal quality indication information received from each first network device, and indicates the first network device with the best signal quality to wake up.

It should be noted that for the heterogeneous network scenarios, the small cell may be in a sleep state. When a to-be-waked-up small cell is selected, a small cell with the best signal quality is selected.

In one implementation, the second network device receives the signal quality indication information of the wake-up signals from one or more first network devices, and selects, based on the signal quality indication information received from one or more first network devices, the first network device with the best signal quality to wake up, namely, start.

In one implementation, the second set condition is: it is determined that the signal quality indicated by the signal quality indication information transmitted by the to-be-waked-up first network device is the best among the N first network devices.

In one implementation, the second set condition is: the signal quality indicated by the signal quality indication information transmitted by the to-be-waked-up first network device is the best and the signal quality is greater than a second set threshold value among the N first network devices. The second set threshold value may be determined by the second network device, or may be determined by the agreement of the communication protocol.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

An example of the present disclosure provides a method for waking up a network device, and the method is performed by a second network device. The method may be executed independently or in conjunction with any other example of the present disclosure. FIG. 10 is a flowchart of a method for waking up a network device according to an example. As shown in FIG. 10, the method includes steps 1001, 1002 and 1003.

In step 1001, receiving signal quality indication information of wake-up signals from N first network devices.

In step 1002, determining, based on the signal quality indication information, a first network device that meets a second set condition from the N first network devices as a to-be-waked-up first network device.

In step 1003, transmitting indication information to the to-be-waked-up first network device, where the indication information is configured to indicate to wake up the to-be-waked-up first network device.

Where N is a positive integer and N≥1.

In one implementation, the second network device receives the signal quality indication information of the wake-up signals from one or more first network devices, and selects, based on the signal quality indication information received from one or more first network devices, the first network device with the best signal quality to wake up, namely, start. Then, the second network device transmits the indication information to the to-be-waked-up first network device, so as to indicate to wake up the to-be-waked-up first network device.

In one implementation, the method further includes: transmitting configuration information to the to-be-waked-up first network device. The configuration information includes duration information of a third set time period, such that the to-be-waked-up first network device performs a wake-up operation in a case of receiving the indication information within the third set time period. The third set time period may be determined by the second network device, or may be determined by the agreement of the communication protocol.

In the above implementation, the user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

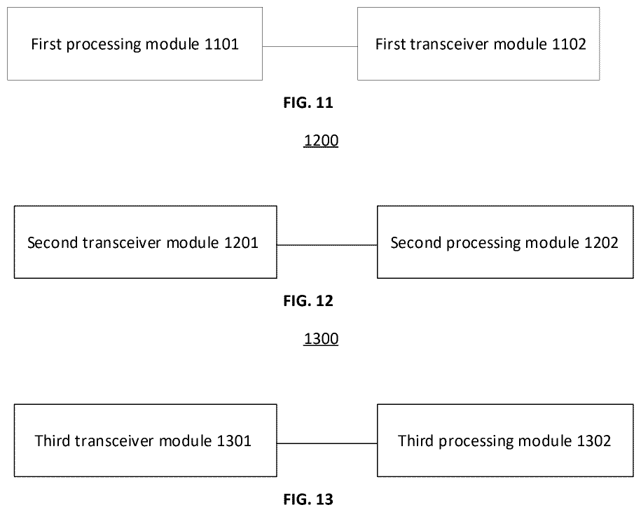

An example of the present disclosure provides a device for waking up a network device 1100, provided in user equipment. Referring to FIG. 11, the device for waking up a network device 1100 includes a first processing module 1101 and a first transceiver module 1102.

The first processing module 1101, configured to determine a transmit power for transmitting a wake-up signal to a first network device; and

the first transceiver module 1102, configured to transmit the wake-up signal to the first network device based on the transmit power.

An example of the present disclosure provides a device for waking up a network device 1200, provided in a first network device. Referring to FIG. 12, the device for waking up a network device 1200 includes a second transceiver module 1201 and a second processing module 1202.

The second transceiver module 1201, configured to receive a wake-up signal from user equipment and transmit signal quality indication information of the wake-up signal to a second network device; and

the second processing module 1202, configured to determine the signal quality indication information.

An example of the present disclosure provides a device for waking up a network device 1300, provided in a second network device. Referring to FIG. 13, the device for waking up a network device 1300 includes a third transceiver module 1301 and a third processing module 1302.

The third transceiver module 1301, configured to receive signal quality indication information of wake-up signals from N first network devices; and

the third processing module 1302, configured to determine a first network device that meets a second set condition from the N first network devices as a to-be-waked-up first network device based on the signal quality indication information,

where N is a positive integer and N≥1.

An example of the present disclosure provides a mobile terminal, including:
a processor; and
a memory that stores processor-executable instructions, where
the processor is configured to execute the executable instructions in the memory to implement the method for waking up the network device performed by a user equipment.

An example of the present disclosure provides a network side device, including:
a processor; and
a memory that stores processor-executable instructions, where
the processor is configured to execute the executable instructions in the memory to implement the method for waking up the network device performed by a first network device.

A network side device is provided according to an example of the present disclosure, and the network side device includes:
a processor; and
a memory that stores processor-executable instructions,
where the processor is configured to execute the executable instructions in the memory to implement the method for waking up the network device performed by a second network device.

An example of the present disclosure provides a non-transitory computer-readable storage medium, storing executable instructions, where the executable instructions, when executed by a processor, implement steps of the method for waking up the network device described above.

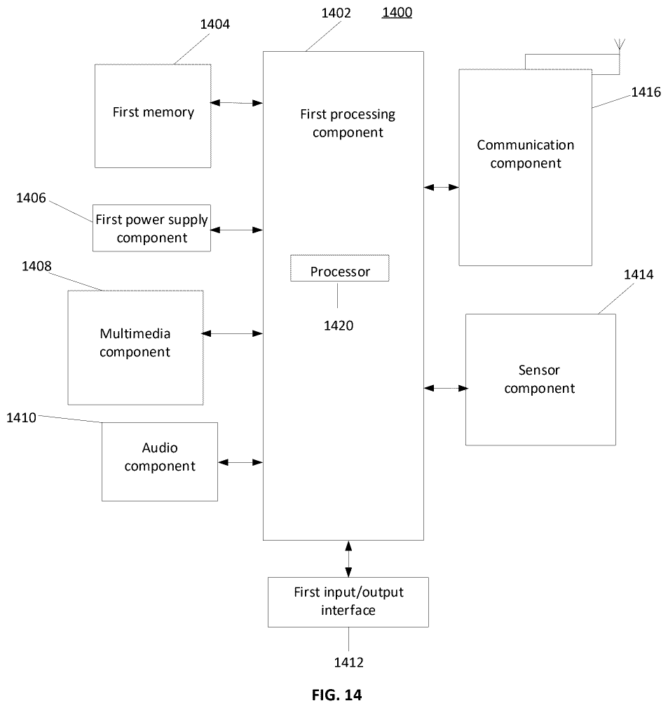

FIG. 14 is a block diagram of a device 1400 for waking up a network device according to an example. For example, the device 1400 may be a mobile phone, a computer, a digital broadcasting terminal, a messaging device, a game console, a tablet device, a medical device, a fitness device, a personal digital assistant, etc.

Referring to FIG. 14, the device 1400 may include one or more of the following components: a first processing component 1402, a first memory 1404, a first power supply component 1406, a multimedia component 1408, an audio component 1410, a first input/output (I/O) interface 1412, a sensor component 1414, and a communication component 1416.

The first processing component 1402 typically controls the overall operation of the device 1400, such as operations associated with display, telephone call, data communication, camera operations, and recording operations. The first processing component 1402 may include one or more processors 1420 to execute instructions to complete all or part of the steps of the above method for waking up a network device. In addition, the first processing component 1402 may include one or more modules to facilitate interaction between the first processing component 1402 and other components. For example, the first processing component 1402 may include a multimedia module to facilitate interaction between the multimedia component 1408 and the first processing component 1402.

The first memory 1404 is configured to store various types of data to support operations at the device 1400. Examples of these data include instructions for any application or method operating on the device 1400, contact data, phonebook data, messages, pictures, videos, etc. The first memory 1404 may be implemented by any type of volatile or nonvolatile storage device or a combination of them, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or a compact disk.

The first power supply component 1406 provides power for various components of the device 1400. The first power supply component 1406 may include a power management system, one or more power sources and other components associated with generating, managing and distributing power for the device 1400.

The multimedia component 1408 includes a screen providing an output interface between the device 1400 and a user. In some examples, the screen may include a liquid crystal display (LCD) and a touch panel (TP). If the screen includes the touch panel, the screen may be implemented as a touch screen to receive an input signal from a user. The touch panel includes one or more touch sensors to sense touch, sliding and gestures on the touch panel. The touch sensor can not only sense the boundary of the touch or sliding operation, but also detect the duration and pressure related to the touch or sliding operation. In some examples, the multimedia component 1408 includes a front camera and/or a rear camera. When the device 1400 is in an operation mode, such as a shooting mode or a video mode, the front camera and/or the rear camera can receive external multimedia data. Each front camera and rear camera can be a fixed optical lens system or have a focal length and optical zoom capability.

The audio component 1410 is configured to output and/or input audio signals. For example, the audio component 1410 includes a microphone (MIC) configured to receive an external audio signal when the device 1400 is in the operation mode, such as a call mode, a recording mode, and a speech recognition mode. The received audio signal may be further stored in the first memory 1404 or transmitted via the communication component 1416. In some examples, the audio component 1410 further includes a speaker for outputting an audio signal.

The first input/output interface (I/O) interface 1412 provides an interface between the first processing component 1402 and a peripheral interface module which can be a keyboard, a click wheel, a button, etc. These buttons may include but are not limited to: a home button, volume buttons, a start button and a lock button.

The sensor component 1414 includes one or more sensors for providing state evaluation of various aspects of the device 1400. For example, the sensor component 1414 can detect an on/off state of the device 1400 and the relative positioning of the components, for example, the component is a display and a keypad of the device 1400. The sensor component 1414 can further detect the change of the position of the device 1400 or one component of the device 1400, the presence or absence of user contact with the device 1400, the azimuth or acceleration/deceleration of the device 1400, and temperature change of the device 1400. The sensor component 1414 may include a proximity sensor configured to detect the presence of nearby objects without any physical contact. The sensor component 1414 may further include an optical sensor, such as a CMOS or CCD image sensor, for use in imaging applications. In some examples, the sensor component 1414 may further include an acceleration sensor, a gyroscope sensor, a magnetic sensor, a pressure sensor, or a temperature sensor.

The communication component 1416 is configured to facilitate wired or wireless communication between the device 1400 and other devices. The device 1400 may access a wireless network based on a communication standard, such as WiFi, 2G or 3G, or a combination of them. In an example, the communication component 1416 receives a broadcast signal or broadcast-related information from an external broadcast management system via a broadcast channel. In an example, the communication component 1416 further includes a near field communication (NFC) module to facilitate short-range communication. For example, the NFC module may be implemented based on the radio frequency identification (RFID) technology, the infrared data association (IrDA) technology, the ultra wideband (UWB) technology, the Bluetooth (BT) technology and other technologies.

In an example, the device 1400 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the above method for waking up a network device.

In an example, a non-transitory computer-readable storage medium including instructions, such as the first memory 1404 including instructions is further provided. The instructions can be executed by the processor 1420 of the device 1400 to complete the above method. For example, the non-transitory computer-readable storage medium may be a ROM, a random access memory (RAM), a CD-ROM, a magnetic tape, a floppy disk, an optical data storage device, etc.

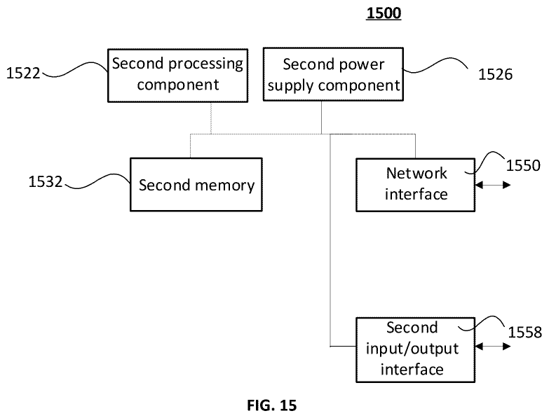

FIG. 15 is a block diagram of a device 1500 for waking up a network device according to an example. For example, the device 1500 may be provided as a base station. Referring to FIG. 15, the device 1500 includes a second processing component 1522 which further includes one or more processors, and a memory resource represented by a second memory 1532 for storing instructions executable by the second processing component 1522, such as an application. The application stored in the second memory 1532 may include one or more modules each corresponding to a set of instructions. In addition, the second processing component 1522 is further configured to execute instructions to perform the method for waking up a network device.

The device 1500 may further include a second power supply component 1526 configured to perform power management of the device 1500, a wired or wireless network interface 1550 configured to connect the device 1500 to a network, and a second input/output (I/O) interface 1558. The device 1500 may operate an operating system stored in the second memory 1532, such as Windows Server™, Mac OS X™, Unix™, Linux™, FreeBSD™, or the like.

Other implementation solutions of the examples of the present disclosure will be apparent to those skilled in the art from consideration of the specification and practice of the present disclosure here. The present application is intended to cover any variations, uses, or adaptations of the examples of the present disclosure following the general principles of the examples of the present disclosure and including such departures from the present disclosure as come within known or customary practice in the art. It is intended that the specification and examples be considered as examples only, with a true scope and spirit of the examples of the present disclosure being indicated by the following claims.

It will be appreciated that the examples of the present disclosure are not limited to the exact construction that has been described above and illustrated in the accompanying drawings, and that various modifications and changes may be made without departing from the scope of the present disclosure. It is intended that the scope of the examples of the present disclosure merely be limited by the appended claims.

### INDUSTRIAL APPLICABILITY

The user equipment transmits the wake-up signal to the first network device with the determined transmit power, and the first network device transmits the signal quality indication information of the wake-up signal to the second network device, such that the second network device selects the first network device with the best signal quality for the wake-up operation. According to the above method, the second network device selects the first network device with the optimal channel quality to the user equipment to be started within the coverage range of the second network device, ensuring the communication effect of the user equipment.

1. A method for waking up a network device, performed by user equipment, comprising:
determining a transmit power for transmitting a wake-up signal to a first network device; and
transmitting the wake-up signal to the first network device based on the transmit power.

2. The method according to claim 1, wherein determining the transmit power for transmitting the wake-up signal to the first network device, comprises:
determining the transmit power based on power parameter information agreed upon by a communication protocol.

3. The method according to claim 2, wherein determining the transmit power based on power parameter information agreed upon by the communication protocol, comprises:
determining the transmit power as an initial transmit power; and
increasing, in response to determining that a network device starting signal meeting a first set condition is not received within a first set time period, the transmit power by a set power step successively until the network device starting signal meeting the first set condition is received within the first set time period or the transmit power is increased to a maximum transmit power,
wherein the power parameter information comprises the initial transmit power, the set power step and the maximum transmit power, and the network device starting signal is from the first network device.

4. The method according to claim 3, wherein the network device starting signal is a synchronizing signal block, and the first set condition is that reference signal receiving power is greater than a first set threshold value.

5. The method according to claim 1, wherein transmitting the wake-up signal to the first network device based on the transmit power, comprises:
transmitting the wake-up signal to the first network device L times within a second set time period based on the transmit power,
wherein L is a positive integer and L≥2.

6. A method for waking up a network device, performed by a first network device, comprising:
receiving a wake-up signal from user equipment;
determining signal quality indication information of the wake-up signal; and
transmitting the signal quality indication information to a second network device.

7. The method according to claim 6, further comprising:
waking up the first network device in response to determining that indication information from the second network device is received within a third set time period; and
not waking up the first network device in response to determining that the indication information from the second network device is not received within the third set time period,
wherein the indication information is configured to indicate to wake up the first network device.

8. The method according to claim 7, further comprising:
receiving configuration information from the second network device; and
determining the third set time period based on the configuration information.

9. The method according to claim 7, further comprising:
determining the third set time period based on an agreement of a communication protocol.

10. The method according to claim 6, further comprising:
transmitting a network device starting signal to the user equipment.

11. The method according to claim 10, wherein the network device starting signal is a synchronizing signal block.

12. The method according to claim 6, further comprising:
entering a sleep state in response to determining that an access message of the user equipment is not received and/or a to-be-transmitted paging message does not exist within a fourth set time period after the first network device is waked up.

13. A method for waking up a network device, performed by a second network device, comprising:
receiving signal quality indication information of wake-up signals from N first network devices; and
determining, based on the signal quality indication information, a first network device that meets a second set condition from the N first network devices as a to-be-waked-up first network device,
wherein N is a positive integer and N≥1.

14. The method according to claim 13, wherein the second set condition is one of:
signal quality indicated by the signal quality indication information transmitted by the first network device is the best among the N first network devices; or
signal quality indicated by the signal quality indication information transmitted by the first network device is the best and the signal quality is greater than a second set threshold value among the N first network devices.

15. The method according to claim 13, further comprising:
transmitting indication information to the to-be-waked-up first network device,
wherein the indication information is configured to indicate to wake up the to-be-waked-up first network device.

16. The method according to claim 15, further comprising:
transmitting configuration information to the to-be-waked-up first network device,
wherein the configuration information comprises duration information of a third set time period, and the to-be-waked-up first network device is waked up in response to determining that the to-be-waked-up first network device receives the indication information within the third set time period.

17.-19. (canceled)

20. A terminal, comprising:
a processor; and
a memory that stores processor-executable instructions, wherein
the processor is configured to execute the executable instructions in the memory to implement the method for waking up the network device according to claim 1.

21. A device, comprising:
a processor; and
a memory that stores processor-executable instructions, wherein
the executable instructions when executed by the processor cause the device to act as the first network device and perform the method according to claim 6.

22. A device, comprising:
a processor; and
a memory that stores processor-executable instructions, wherein
the executable instructions when executed by the processor cause the device to act as the second network device and perform the method according to claim 13.

23. A non-transitory computer-readable storage medium, storing one or more programs configured to be executed by one or more processors of user equipment, the one or more programs comprising instructions which, when executed by the one or more processors, cause the user equipment to perform the method according to claim 1.
